(19) United States
(12) Patent Application Publication
(10) Pub. No.: US 2004/0055168 A1
(43) Pub. Date: Mar. 25, 2004

(54) Inside / outside scribe

(76) Inventor: Robert Thomas Allen, Vancouver (CA)

Correspondence Address: Robert Thomas Allen, 3179 East 16th Ave., Vancouver, BC, V5M 2M7, CA

(21) Appl. No.: 10/615,940

(22) Filed: Jul. 10, 2003

(30) Foreign Application Priority Data
Jan. 19, 2001 (CA) 2,335,874

(51) Int. Cl. B43L 13/02

(52) U.S. Cl. 33/42

(57) ABSTRACT

The invention is an improved, hand-held, adjustable, graduated marking gauge and scribe for carpentry and related activities. It is used to mark work-pieces at a given distance from an adjacent edge or intersecting surface such as is encountered when fitting cabinets or trim to uneven wall surfaces, or in the spiling of boat planking or the marking of cut-outs relative to an edge. The device consists of a main body, upon which are etched scales and which is bent and formed at one end to create an edge follower and a corner follower and upon which is mounted a sliding and fixable instrument holder which holds marking, cutting or other instruments, inserted therein, in an adjustable fashion. The displacement of the centre-line of the marking instrument relative to the edge follower or the corner follower is read on the scales at the corresponding side of the instrument holder.

### CROSS-REFERENCE TO RELATED APPLICATIONS

Not applicable

### STATEMENT REGARDING FEDERALLY SPONSORED RESEARCH DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND

The invention is a response to the needs of carpenters, building trades technicians and other s who need to mark or trim work pieces parallel to either an inside or outside edge. This is exemplified by the scribing process involved in fitting a counter top to an uneven wall or in marking out a border to be painted around the perimeter of a sign.

There are many tools on the market which perform either inside edge marking, scoring or cutting functions, such as the “Adjustable gauge”, U.K. Patent number GB2197614, invented by Cryan; Henry Joseph or the tradiditional log scribe type. There are outside edge marking, scoring and cutting tools such as the “Scoring Devise With Edge Guide”, U.S. Pat. No. 4,030,195, invented by Insolio; Thomas A. orthe traditional mortise gauge type tools. The Inside/Outside Scribe offers the user both inside edge and outside edge marking, scoring and cutting abilty. The invention is also a tool that is compact, cost effective, conveneint and easy to use.

### BRIEF SUMMARY OF THE INVENTION

The invention is a hand held scribing and gauging tool which has been designed for use by building trades workers to quickly perform marking, scoring or cutting tasks relative to inside corners, such as fitting cabinets or tiles to uneven walls or to mark work pieces relative to outside edges for such functions as blind fastening or painting borders. Marking, scoring or cutting instruments may be used in the tool to perform those functions. The chosen instument is paced in the instrument holder which slies along the body of the tool and fixed at a given distance the end of the tool which is either hooked over or butted int a corner and moved along said corner to produce a mark, score or cut line at the desired distance from the corner or edge.

### BRIEF DESCRIPTION OF THE SEVERAL VIEWS OF THE DRAWING

FIG. 1, Cross section of FIG. 2 at aa with thumbscrews aligned.

FIG. 2, Face view of Inside/Outside Scribe, body and instrument holder.

FIG. 3, Side view of body and end view of instrument holder with thumbscrews aligned.

FIG. 4, Side view of instrument holder with aligned thumbscrews.

FIG. 5, Top view of instrument holderwithout thumbscrews.

FIG. 6, End view of instrument holder with aligned thumbscrews.

FIG. 7, Bottom view of instument holder without thumbscrews.

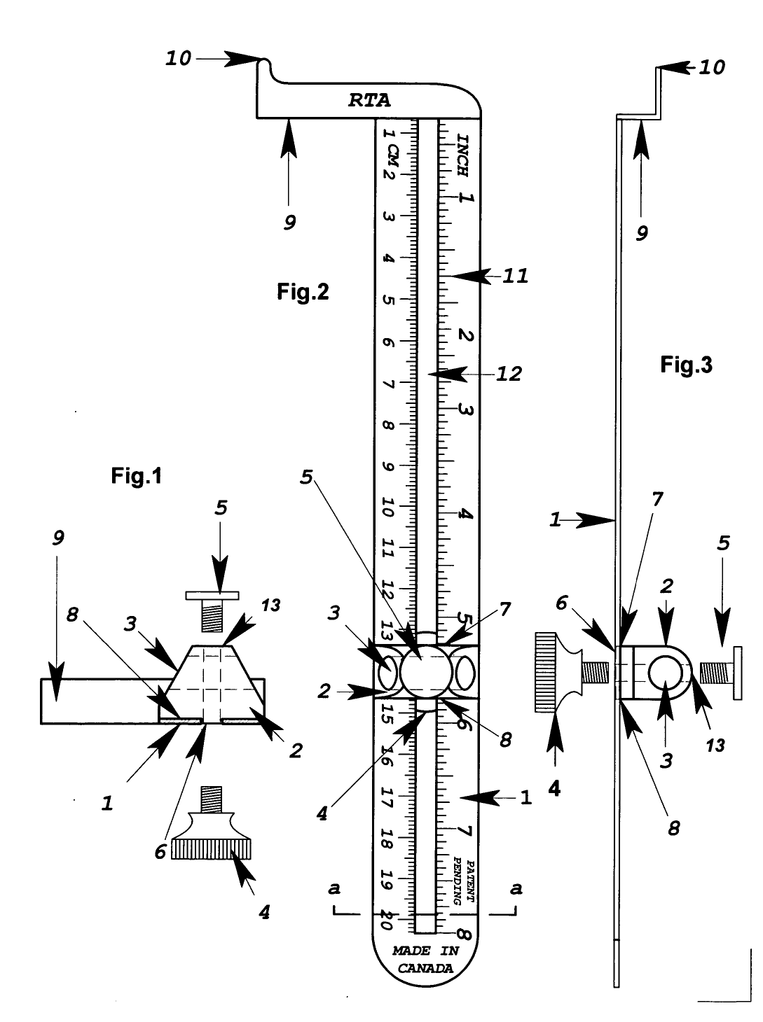

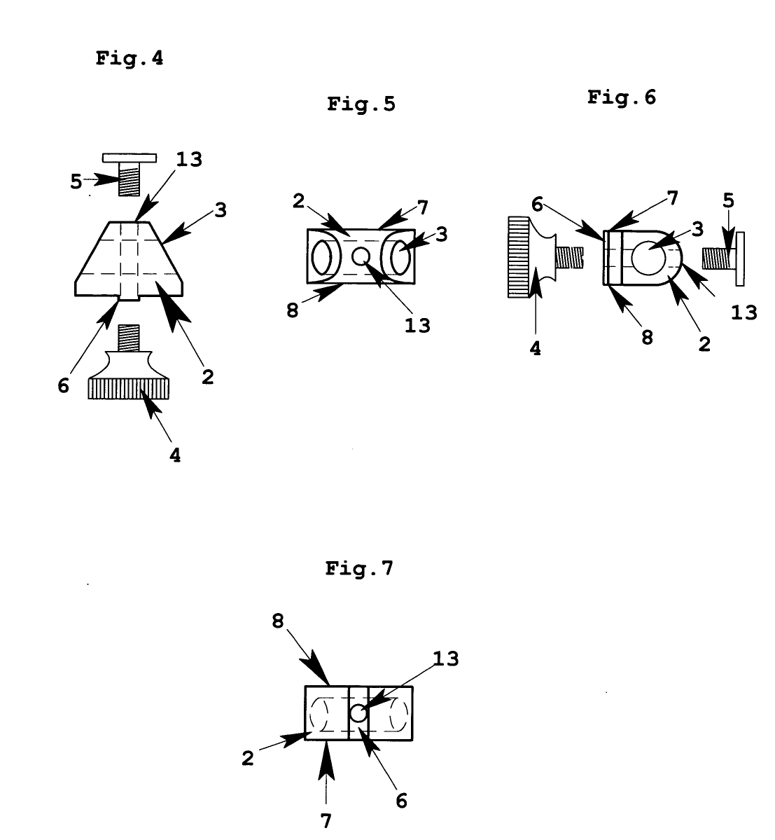

### DETAILED DESCRIPTION OF THE INVENTION

In the advantageous embodiment of the inside/outside scribe, as seen in the drawings,the tool consists of an elongate body 1, made of a rugged material such as stainless steel, which is bent and formed at one end thereof, creating an edge follower 9, and a corner follower 10. Upon the body is mounted a sliding and fixable instrument holder 2, made of suitable material, such as anodised aluminium, which holds, adjustably and releasably, by means of a thumbscrew 5, screwed into threaded hole 13, marking cutting or other instruments which are inserted through hole 3, and adjusted for intended use. Scales 11, are etched into and printed onto the face side of the body 1. The instrument holder 2, is slidably and stopably mounted on the body 1, by means of a large, machined or cast metal or moulded polymer, (with inserted, threaded metal stud), shouldered thumbscrew 4, which passes through a slot 12, cut out of the body 1 and is screwed into threaded hole 13, of the instrument holder 2. The thickness of the instrument holder 2, is advantageously equal to the distance between the corner follower 10, and the edge follower 9, thereby creating a relationship between the far cursor edge 8, and the corner follower 10, whereby the distance from the corner follower 10, to the centre-line of an instrument being held in hole 3, of the instrument holder 2, can be directly read, adjacent to the far cursor edge 8, on the preferred, etched and inked scale 11, which is aligned with a plane parallel to the edge follower 9, and laying halfway between the edge follower 9, and the corner follower 10, and represents zero. A corollary relationship therefor exists between the near cursor edge 7, and the edge follower 9, whereby the distance from theedge follower 9, to the centre-line of an instrument mounted in the instrument holder 2, may be directly read on the scale 11, adjacent to the near cursor edge 7. A nub 6, protrudes from the bottom of the instrument holder 2, which acts to align the instrument holder 2, in the slot 12, as it is mounted on the body 1. A plane formed by the centre-line of the held instrument and the corner follower 10, is roughly parallel to the main portion of the body, insuring relative accuracy of performance as the tool may be held at an approximate right angle to straight edges and adjacent surfaces and normal to curved edges and surfaces.

I claim as my invention:

1. A hand tool for scribing, marking or cutting materials, consisting of a longitudinal body, an offset analog member attached to one end of the body and an instrument holder which is slidably and stopably mounted on the body.

2. A tool as described in claim 1, in which the analog member performs the dual functions of following either an inside or outside edge.

3. A tool as described in claim 1 or claim 2, which has scales marked on its body which are located in such a way that when read at cursor edges on the instrument holder, such reading represents the displacement of the centre-line of the held instrument from the analog follower which is related to the cursor.

4. A tool as described in claim 1 or claim 2 or claim 3, in which the displacement of the inside follower to the outside follower of the analog member is equal to the displacement of the two cursor edges of the instrument holder, allowing the user to read the position of the centre-line of the held instrument, relative to either the inside or the outside follower, on the same scale.
